(19) United States
(12) Patent Application Publication
(10) Pub. No.: US 2010/0064095 A1
(43) Pub. Date: Mar. 11, 2010

(54) Flash memory system and operation method

(76) Inventors: Ming-Dar Chen, Hsinchu City (TW); Chuan-Sheng Lin, Jhubei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/382,447

(22) Filed: Mar. 17, 2009

(30) Foreign Application Priority Data
Sep. 5, 2008 (TW) 97134038

(51) Int. Cl. G06F 12/08; G06F 12/00; G06F 12/02

(52) U.S. Cl. 711/103; 711/118; 711/E12.008; 711/E12.001; 711/E12.017

(57) ABSTRACT

The present invention discloses a flash memory system comprising: a cache memory, a cache memory interface, a host interface, a flash memory interface, and a microprocessor The cache memory interface contains an arbitrator for performing data bus bandwidth time sharing process to access the cache memory The host interface is used for receiving data from a host system, and storing the data into the cache memory to form ready data The flash memory interface reads the ready data from the cache memory and stores it into at least one flash memory The microprocessor is used for controlling the host interface and the flash memory interface to access the cache memory Hence, the present invention can achieve the purpose of enhancing the access efficiency and increasing the life of the flash memory

### BACKGROUND OF THE INVENTION

1. Field of the Invention

The present invention relates to a flash memory system, and more particularly to a flash memory system having a cache memory and its operation method.

2. Description of Related Art

In recent years, semiconductor technologies advance rapidly, and thus the capacity of various different storage memories is increased drastically. Among present general nonvolatile memories, flash memory is the most popular one. Since the flash memory features the advantages of a fast access, a high shock resistance, a good power-saving effect and a small size, etc, the flash memory has been used extensively in different electronic products and devices (such as memory cards, flash sticks, solid state disks (SSD), personal digital assistants (PDA), digital cameras and computer devices), and served as an important medium for storing data.

However, the flash memory has to face the life issue, which is about the bearable erase cycle of the flash memory when the flash memory is applied in a storage system. As well known, the flash memory will erase the blocks before writing data into the blocks. In general, the bearable erase cycle of the flash memory is approximately equal to 10,000 to 100,000 times, and such a frequent access will affect the life of the flash memory significantly.

To overcome the foregoing shortcoming, manufacturers adopt a wearing-leveling design. During data processing process, an algorithm is used for avoiding an excessive use of a certain block and preventing the formation of bad blocks by using the memory blocks of the flash memory uniformly to enhance the life of the flash memory. If the number of bad blocks approaches the number of spare blocks, then the flash memory cannot provide effective replacement space and will shorten the life of flash memory. Although the aforementioned design method can extend the life of the flash memory, the repeated erases will still affect the life of the flash memory.

To reduce the number of erases and further enhance the life of the flash memory, related manufacturers proposed a way of buffering a desired write-in data into a cache memory first, and then writing the data into the flash memory to reduce the erase cycle when the data is written into the flash memory. Since it is necessary to add a cache memory in the storage system for storing data, it will occupy a portion of the processing timing of a microprocessor of the storage system, and lower the overall working efficiency of the storage system.

Therefore, enhancing the life of flash memory as well as concurrently taking the access performance of the storage system into consideration demands immediate attention and feasible solutions.

### SUMMARY OF THE INVENTION

In view of the foregoing shortcomings of the prior art, the present invention overcomes the shortcomings by adding a cache memory in the flash memory system for buffering data, and preventing the temporary storage of the data from affecting the access efficiency of the flash memory system, so as to extend the life of the flash memory and enhance the data access efficiency of the flash memory system.

To achieve the foregoing objective, the present invention provides a flash memory system comprising: a cache memory, a cache memory interface, a host interface, a flash memory interface and a microprocessor, wherein the cache memory interface is coupled to the cache memory, and the cache memory interface further comprises an arbitrator for executing a time sharing process to access the cache memory. The host interface is provided for receiving data from the host system and buffering the data into the cache memory as ready data. The flash memory interface is coupled to at least one flash memory for reading the ready data from the cache memory and storing the ready data into the flash memory. Finally, the microprocessor is provided for controlling the host interface and the flash memory interface to access the cache memory. With the time sharing process of the arbitrator through the cache memory interface, the host interface, the flash memory interface and the microprocessor can access the cache memory synchronously.

The present invention further provides an operation method of the flash memory system, wherein the flash memory system comprises a cache memory, having at least two cache blocks, and the operation method comprises the steps of: receiving data, buffering the data into a corresponding cache block according to a logical block address of the data, indicating the data as ready data, repeating the receipt of data and buffering the data into the original cache block until the logical block address of the received data is situated at a corresponding logical block address of another cache block, buffering the data into another cache block, and writing the ready data buffered in the original cache block into an empty physical block of the flash memory while buffering the data into the other cache block. By repeating the aforementioned procedure, we complete the operation of the flash memory system to achieve a synchronous access process of the flash memory in the flash memory system while executing the processes of buffering and writing data.

The above and other objects, features and advantages of the present invention will become apparent from the following detailed description taken with the accompanying drawing.

### BRIEF DESCRIPTION OF THE DRAWINGS

FIG. 1 is a block diagram of a flash memory system in accordance with a preferred embodiment of the present invention;

FIG. 2 is a schematic view of a structure of a cache memory in accordance with the present invention;

FIG. 3 is a schematic view of accessing a cache memory in accordance with a preferred embodiment of the present invention;

FIGS. 4A and 4B are schematic views of data processing of a memory in accordance with a first preferred embodiment of the present invention;

FIGS. 5A and 5B are schematic views of data processing of a memory in accordance with a second preferred embodiment of the present invention; and

FIG. 6 is a flow chart of an operation method of a flash memory system in accordance with a preferred embodiment of the present invention.

### DETAILED DESCRIPTION OF PREFERRED EMBODIMENTS

The present invention adds a cache memory in the flash memory system to process data in the cache memory to reduce write and erase cycle in the flash memory, before the written data is stored into the flash memory. With a time sharing process of data bus bandwidth, the cache memory can be accessed according to an appropriate allocation, and a design of different cache blocks of the cache memory is provided for the invention to control different cache blocks to buffer and write data into the flash memory synchronously, so as to enhance the access efficiency of the flash memory system and the life of the flash memory effectively.

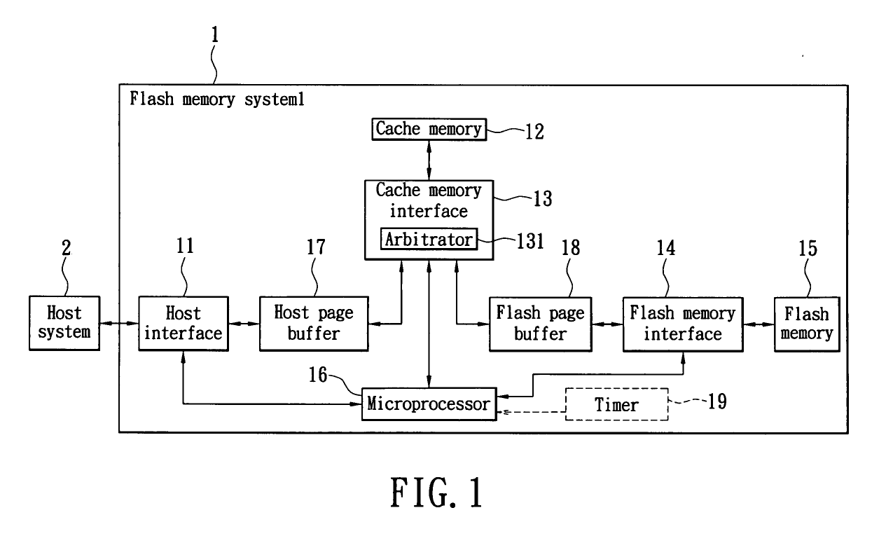

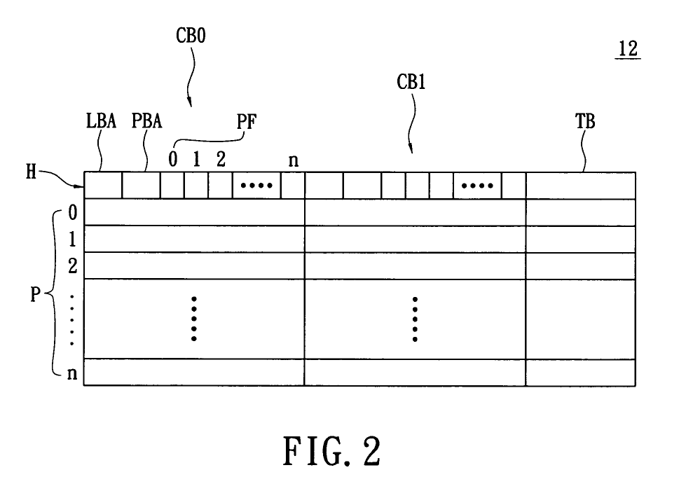

With reference to FIGS. 1 and 2 for a block diagram of a preferred embodiment of a flash memory system and a schematic view of a structure of a cache memory in accordance with the present invention respectively, a flash memory system 1 as shown in FIG. 1 is applied for accessing data. The flash memory system 1 comprises a host interface 11, a cache memory 12, a cache memory interface 13, a flash memory interface 14, at least one flash memory 15 and a microprocessor 16. The host interface 11 is connected to a host system 2 for receiving data outputted from the host system 2.

The cache memory interface 13 is used for connecting and controlling the cache memory 12, and further comprises an arbitrator 131 for operating a time sharing process to access the cache memory 12. If the host interface 11 receives data, the data will be buffered into the cache memory 12 through the cache memory interface 13, and will become ready data after going through a confirmation.

The flash memory interface 14 is provided for connecting and controlling the flash memory 15. The flash memory interface 14 will read data that is confirmed as ready data from the cache memory 12 through the cache memory interface 13 and store the data into the flash memory 15.

The microprocessor 16 is connected to the host interface 11, the cache memory interface 13 and the flash memory interface 14 for controlling the host interface 11 and the flash memory interface 14 to read or write data in the cache memory 12. Therefore, the flash memory system 1 in accordance with the preferred embodiment can allocate the data bus bandwidth between the cache memory interface 13 and the cache memory 12 to the host interface 11, the flash memory interface 14 and the microprocessor 16 through the time sharing process operated by the arbitrator 131 of the cache memory interface 13, so that the host interface 11, the flash memory interface 14 and the microprocessor 16 can synchronously access the cache memory 12 through cache memory interface 13 to enhance the access efficiency of the flash memory system 1 significantly. The flash memory system 1 of the invention further comprises a host page buffer 17 and a flash page buffer 18, wherein the host page buffer 17 is connected between the host interface 11 and the cache memory interface 13 for buffering data provided for the cache memory interface 13 to avoid the situation that the cache memory 12 cannot provide a complete block for an access when the data is buffered to the cache memory 12. Similarly, the flash page buffer 18 is connected between the cache memory interface 13 and the flash memory interface 14 for buffering data when the data is transmitted between the cache memory 12 and the flash memory 15.

The cache memory 12 of a preferred embodiment of the present invention as shown in FIG. 2 can be divided into two cache blocks (a first cache block CB0 and a second cache block CB1) and a lookup table space TB. In the design for practical applications, the cache memory 12 can be divided into at least two cache blocks, but the embodiment is used for illustrating the present invention only, but not intended for limiting the scope of the invention. The space TB of the cache memory 12 is provided for storing a logical/physical address lookup table according to the actual application design. The first cache block CB0 and the second cache block CB1 are provided for receiving and buffering the data transmitted from the host interface 11. After the data is buffered into the first cache block CB0 or the second cache block CB1 and confirmed and processed to become ready data, the ready data is provided for the flash memory interface 14. The actual processing procedure among the cache blocks of the cache memory 12 is described as follows.

Firstly, each of the first cache block CB0 and the second cache block CB1 comes with a head information H, and the header information H is further divided into a logical block address field LBA, a physical block address field PBA and a group of page flag fields PF0˜PFn, wherein the logical block address field LBA and the physical block address field PBA are provided for indicating the corresponding logical block address and physical block address of the cache block CB0 or CB1, and the page flag fields PF0˜PFn are provided for indicating the validity of the data buffered in different pages of the cache block CB0 or CB1.

In addition, the first cache block CB0 and the second cache block CB1 further comprise a plurality of page addresses P0˜Pn, and the microprocessor 16 is provided for controlling the host interface 11 to write data into the page addresses P0˜Pn of the first cache block CB0 or the second cache block CB1 by using a logical page as a unit. The page flag fields PF0˜PFn are the page addresses P0˜Pn of the corresponding cache blocks provided for indicating the validity of the data buffered in the page addresses P0˜Pn respectively. In other words, if the data is buffered into a cache block, the microprocessor 16 will update a corresponding page flag field PF0˜PFn to indicate the data as valid data, and after the data is indicated as the valid data, such record of data is a desired data to be written into the flash memory 15 and becomes ready data. In this preferred embodiment, if one of the page flag fields PF0˜PFn is set to “1”, it indicates that the data buffered into the corresponding page address is valid data. On the contrary, “0” stands for invalid data, and other methods can also be used for indicating the validity of the buffered data.

In actual designs, the cache memory 12 can be nonvolatile memory such as a ferroelectric random access memory (FeRAM), a magnetic random access memory (MRAM) or a phase-change random access memory (PRAM), or a volatile memory such as a static random access memory (SRAM), etc. The flash memory system 1 further comprises a timer 19 for generating a predetermined time to the microprocessor 16, such that the microprocessor 16 can control the data buffered into the cache memory 12 to be written into the flash memory 15 once every predetermined time.

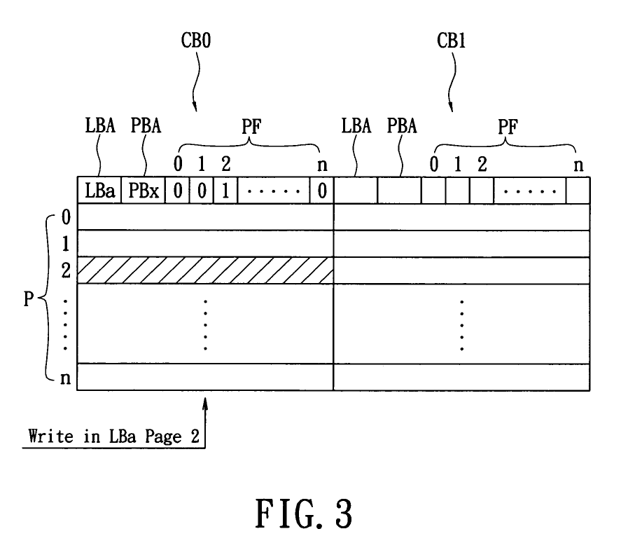

With reference to FIG. 3 for a schematic view of accessing a cache memory in accordance with a preferred embodiment of the present invention, if the host interface 11 receives data of a second logical page (Page 2) of a logical block a (LBa) transmitted from the host system 2, and buffers the data into the cache memory 12, and the logical block address of the data is situated at a corresponding logical block address of the first cache block CB0, then the data will be written into the second page address P2 of the first cache block CB0 and a corresponding page flag field PF2 will be set to “1” indicating that the buffered data is valid data. If the logical address of the data is also situated at the logical block a (LBa), then the page address corresponding to the first cache block CB0 will be updated, and the buffered data will be indicated as valid data. If the logical address of the data is the same as the previous record of data (which is situated at the second logical page P2), then the previous record of data will be overwritten.

In addition, the address of the logical block a (LBa) corresponds to an address of the physical block x (PBx), and the physical block address field PBA as shown in FIG. 3 is provided for storing PBx information.

The data process flow between the cache memory 12 and the flash memory 15 is further illustrated by a preferred embodiment of a memory data processing process in accordance with the present invention as follows.

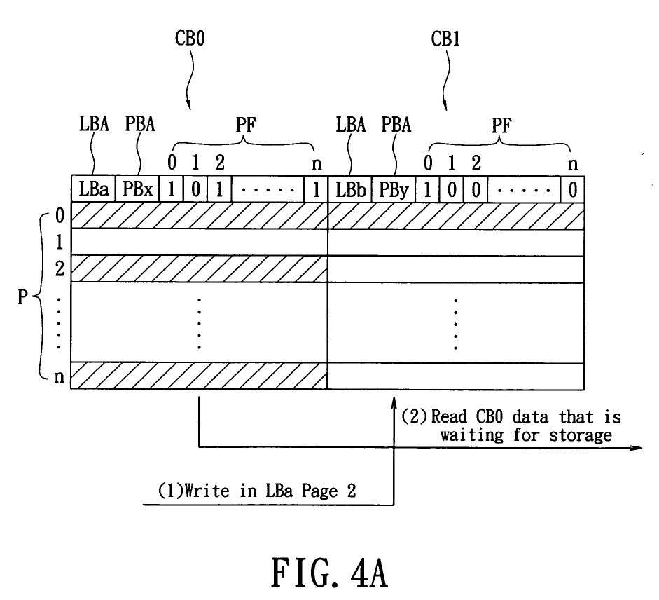

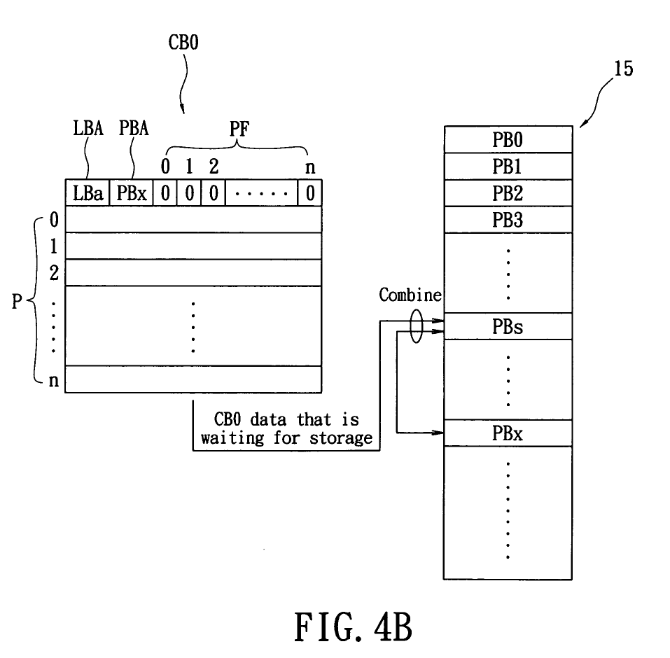

With reference to FIGS. 4A and 4B for schematic views of data processing of a memory in accordance with a first preferred embodiment of the present invention, the page addresses P0, P2 and Pn shown in FIG. 4A indicate that data are buffered into the memory with the aforementioned page addresses, and the data are valid data and become ready data.

If the flash memory system 1 receives data of a zero logical page (Page 0) from another record of logical block b (LBb), the microprocessor 16 will control the host interface 11 and the cache memory interface 13 to buffer the data into a P0 page address of the second cache block CB1 (as shown in Step 1 of FIG. 4A), and if the received data is also situated at a corresponding logical block address of the second cache block CB1, then the data will be written or overwritten into the second cache block CB1 directly.

While the Step (1) is being executed, the microprocessor 16 will confirm that the data in the first cache block CB0 are not all ready data according to the page flag fields PF0˜PFn of the first cache block CB0, and the microprocessor 16 synchronously will execute a combined writing procedure (as shown in Step 2 of FIG. 4A) for controlling the cache memory interface 13 and the flash memory interface 14 to read the ready data from the first cache block CB0, and the ready data read from the first cache block CB0 as shown in FIG. 4B will be combined with the data in a corresponding physical block (PBx) of the first cache block CB0, and the combined data will be written into an empty physical block (PBs) of the flash memory 15. The combined writing refers to writing the ready data stored in the first cache block CB0 into an empty physical block (PBs) of the flash memory 15, and the rest of data of the non-updated page address will be read from the corresponding physical block (PBx) of the first cache block CB0 and written into a corresponding physical block (PBs) to achieve the combined writing procedure.

After the microprocessor 16 controls the combined data to be written into the empty physical block (PBs) of the flash memory 15, the page flag fields PF0˜PFn of the first cache block CB0 will be updated to indicate that the ready data written into the flash memory 15 are invalid data, and the data in the address of the physical block (PBx) of the flash memory 15 and corresponding to the first cache block CB0 will be erased, and the address of the logical block LBa corresponds to the address of the physical block PBs.

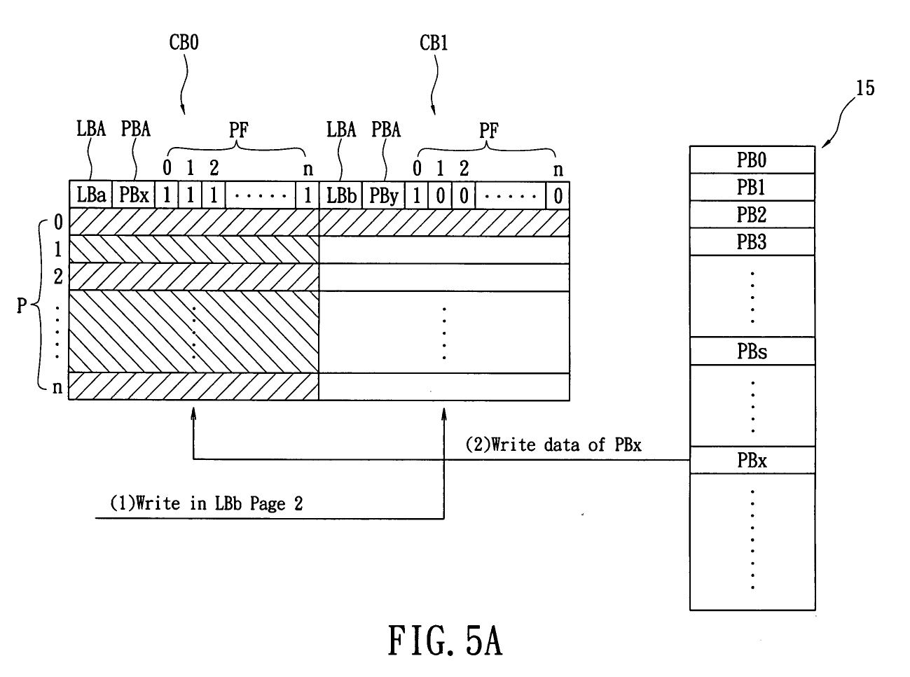

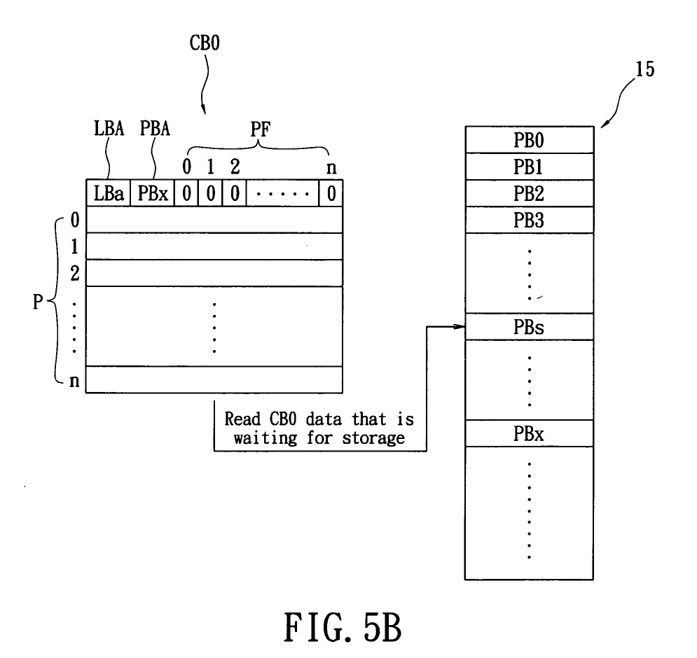

With reference to FIGS. 5A and 5B schematic views of data processing of a memory in accordance with a second preferred embodiment of the present invention, FIG. 3 is also used for illustrating this preferred embodiment, and the first cache block CB0 has buffered the ready data into the page addresses of P0, P2 and Pn as shown in FIG. 5A, and the data are indicated as valid data and become ready data.

Similarly, after another record of data of a zero logical page (Page 0) of a logical block b (LBb) is received, the data corresponding to the logical block address of the first cache block CB0 is transferred and situated at a logical block address corresponding to the second cache block CB1. The microprocessor 16 will control the host interface 11 to buffer the data into a P0 page address of the second cache block CB1 (as shown in Step 1 of FIG. 5A). Now, the microprocessor 16 will confirm that the data in the first cache block CB0 are not all ready data according to the page flag fields PF0˜PFn of the first cache block CB0, so that the combined writing procedure (as shown in Step 2 of FIG. 5A) is executed to control the cache memory interface 13 and the flash memory interface 14 to write in the address of a physical block (PBx) of the flash memory 15 corresponding to the first cache block CB0, read data from the page address (not indicated as a page address of the ready data) and not written into the corresponding first cache block CB0, and duplicate the page data into a corresponding page address of the first cache block CB0. In other words, besides the page addresses P0, P2 and Pn, all other page data in the cache block CB0 are duplicated from the corresponding data page of the physical block (PBx) in the flash memory 15. The status of the page flag fields PF0˜PFn of the cache block CB0 is updated, indicating that the data in the cache block CB are valid data.

With reference to FIG. 5B, all data indicated as ready data in the first cache block CB0 are written into empty physical blocks (PBs) of the flash memory 15 to update the status of the page flag fields PF0˜PFn of the first cache block CB0, and the data in the address of the physical block (PBx) of the flash memory is erased, and the address of the logical block LBa corresponds to the address of the physical block PBs.

In the aforementioned memory data processing process in accordance with the first and second preferred embodiments of the present invention, the microprocessor 16 can transmit or process the data between the cache memory 12 and the flash memory 15 during the combined writing procedure by buffering the data into the flash page buffer 18 first.

After the logical block address of the received data is transferred from the original cache block and situated at a corresponding logical block address of another cache block, and the microprocessor 16 confirms that all data stored in the original cache block are ready data according to the page flag fields PF0˜PFn of the original cache block, and the data of the entire original cache block are written into an empty physical block of the flash memory 15 directly, and the page flag fields PF0˜PFn of the original cache block are updated to indicate that the ready data written into the flash memory 15 are invalid data, and the data corresponding to the address of a physical block of the flash memory 15 corresponding to the original cache block are erased, and the correspondence of the logical/physical address lookup table is updated.

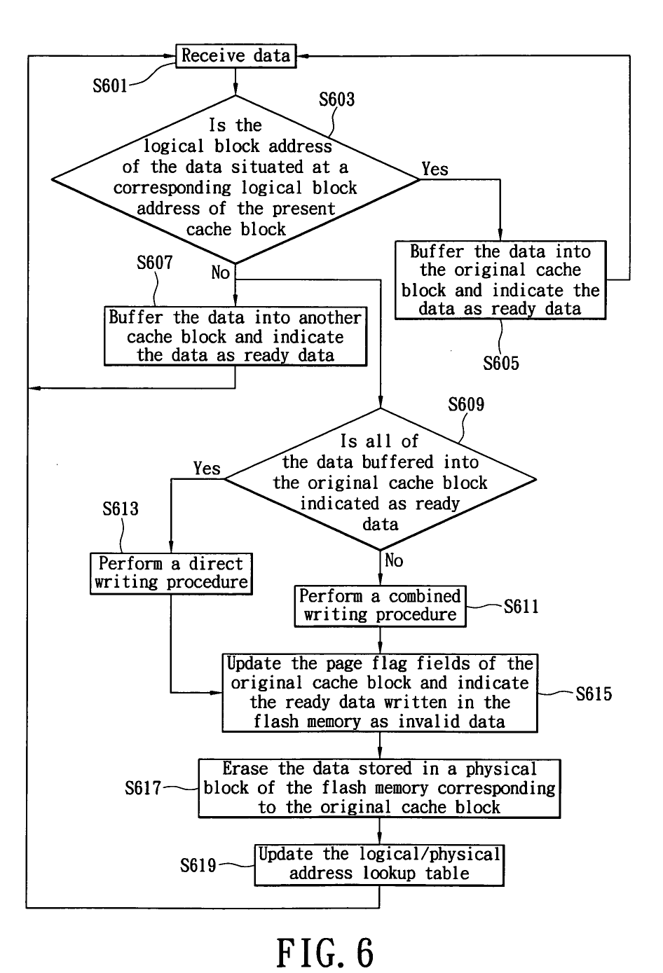

With reference to FIG. 6 for a flow chart of an operation method of a flash memory system in accordance with a preferred embodiment of the present invention to further disclose the actual operation procedure of the present invention, the present invention provides an operation method of the flash memory system, and the method comprises the following steps:

Receive data (S601), and determine whether or not the logical block address of the data is situated at a corresponding logical block address of the present cache block (S603).

If the determination result of Step (S603) is affirmative, then it indicates that the present received data and the previous record of data are buffered into a same cache block, and thus the received data is buffered into the original cache block directly, and then the page flag fields of the original cache block are updated to indicate the data are valid data and become ready data (S605). If the determination result of Step (S603) is negative, then it indicates that the logical block address of the present received data is transferred from the original cache block and situated at a corresponding logical block address of another memory block. In other words, the present received data and the previous record of data are data stored in different memory blocks, and thus it is necessary to buffer the data into different cache blocks for buffering the present received data into another cache block, and the page flag fields in the other cache block will be updated to indicate that the data are valid data and become ready data (S607), after the Step (S605) or (S607), the Step (S601) for receiving data takes place. If the received data is situated at the same cache block of the previous record of data which is the data stored in the same memory block, the received data will be written into the corresponding cache block.

If the determination result of the Step (S603) is negative and the Step (S607) is executed, then the following steps will be carried out. The original cache block is determined whether or not data are filled, and these data are indicated as ready data (S609). If the determination result of the Step (S609) is negative, then it indicates that there is partial ready data stored in the original cache block, then a combined writing procedure will be performed (S611) to combine the ready data in the original cache block with the data in the address of the corresponding flash memory physical block of the original cache block, and the combined data is written into a usable physical block (erased physical block) of the flash memory.

On the contrary, if the determination result of Step (S609) is affirmative, then it indicates that the data in the entire original cache block are indicated as ready data, then a direct writing procedure will be executed (S613), without the need of combining other data, but directly writing the ready data stored in the original cache block into a usable physical block (or an erased physical block) into the flash memory. After the writing procedure as shown in Step (S611) or (S613) takes place, the page flag fields of the original cache block are updated to indicate that the ready data written in the flash memory are invalid data (S615), such that other data can be received and buffered continuously. After the Step (S615) takes place, the data stored in a physical block of the flash memory corresponding to the original cache block (S617) is erased, and the logical/physical address lookup table is updated, and the data of the logical block address of the original cache block corresponds to the address for writing in the aforementioned data into the physical block as described in the Step S611 or S613 (S619). By repeating the procedure as described in this preferred embodiment, the flash memory system in accordance with the present invention can complete the data accessing operation.

In summation of the description above, the present invention adds a cache memory for processing data in the cache memory to reduce the write and erase procedures of the flash memory before the data is written and stored in the flash memory, and allows the cache memory to be accessed according to an appropriate allocation through a time sharing process of data bus bandwidth. In addition, the present invention controls the access of different cache blocks in the cache memory to achieve the effect of executing the procedures of buffering and writing data into the flash memory synchronously, so as to enhance the access efficiency of the flash memory system and the life of the memory.

In the present invention, the logical/physical address lookup table can be stored in a lookup table space TB of a cache block or in other spaces such as a file system of a host system.

Although the present invention has been described with reference to the preferred embodiments thereof, it will be understood that the invention is not limited to the details thereof Various substitutions and modifications have been suggested in the foregoing description, and others will occur to those of ordinary skill in the art Therefore, all such substitutions and modifications are intended to be embraced within the scope of the invention as defined in the appended claims.

What is claimed is:

1. A flash memory system, comprising:
a cache memory, having at least two cache blocks; and
an arbitrator, coupled to the cache memory, for allocating and accessing different cache blocks by a time sharing process of data bus bandwidth according to the data to be read or written.

2. The flash memory system of claim 1, wherein the cache memory further comprises a logical/physical address space for storing a logical/physical address lookup table.

3. The flash memory system of claim 1, further comprising:
a host interface, for receiving data of the host system and buffering the data into the cache memory as ready data;
a flash memory interface, coupled to at least one flash memory, for reading the ready data from the cache memory and storing the ready data into the flash memory; and
a microprocessor, for controlling the host interface and the flash memory interface to access the cache memory.

4. The flash memory system of claim 3, wherein each cache block comprises a header information for indicating information related to the corresponding cache block of the flash memory including a logical block address, a physical block address, and the validity of the data buffered in the cache block.

5. The flash memory system of claim 4, wherein the header information indicates the validity of the buffered data by means of a group of page flag fields.

6. The flash memory system of claim 5, wherein the microprocessor controls the host interface to write the data with a logical page as a unit into the cache block of the cache memory, and then the microprocessor updates the group of page flag fields to indicate that the data is valid data and produce ready data.

7. The flash memory system of claim 6, wherein if the logical block address of the data is transferred from the logical block address corresponding to one of the cache blocks and situated at the logical block address corresponding to the other cache block, then the data is written into the other cache block, and synchronously a combined writing procedure or direct writing procedure for the ready data stored in the original cache block is executed.

8. The flash memory system of claim 7, wherein if non-ready data exists in the original cache block, then the microprocessor will execute the combined writing procedure to combine the ready data in the original cache block and the data in a corresponding flash memory physical block address of the original cache block, and write the combined data into an empty physical block of the flash memory.

9. The flash memory system of claim 8, wherein the ready data written into the flash memory is indicated as invalid data, and the data corresponding to the flash memory physical block address of the original cache block is erased, after the combined data is written into the empty physical block of the flash memory.

10. The flash memory system of claim 7, wherein the microprocessor will execute the direct writing procedure to write the ready data into an empty physical block of the flash memory directly, if the original cache block is filled up with the buffered data, and the data are indicated as ready data.

11. The flash memory system of claim 1, wherein the cache memory is a ferroelectric random access memory (FeRAM), a magnetic random access memory (MRAM), a phase-change random access memory (PRAM), a static random access memory (SRAM) or a combination of the above.

12. The flash memory system of claim 3, further comprising a timer, for controlling the microprocessor to write the data buffered in the cache memory into the flash memory once every predetermined time.

13. The flash memory system of claim 3, further comprising:
a host page buffer, coupled between the host interface and the cache memory interface, for buffering the data and providing the data to the cache memory interface; and
a flash page buffer, coupled between the cache memory interface and the flash memory interface, for buffering the data written in the flash memory.

14. An operating method of a flash memory system as recited in claim 1, comprising the steps of:
(a) receiving the data;
(b) buffering the data into one of the corresponding cache blocks according to the logical block address of the data to indicate that the data becomes ready data;
(c) repeating the steps (a) and (b), until the logical block address of the data is transferred and situated at another logical block address, and buffering the data into the other cache block; and
(d) performing a writing procedure at the same time of executing Step (c) for buffering the data into the other cache block, so as to write the ready data buffered in the original cache block into an empty physical block of the flash memory;
thereby, the operation of the flash memory system is completed by repeating the steps (a) to (d).
